(19) United States
(12) Patent Application Publication
(10) Pub. No.: US 2025/0134064 A1
(43) Pub. Date: May 1, 2025

(54) SYSTEM AND METHOD FOR ANIMALIA IDENTIFICATION AND SPECIES-SPECIFIC INTERACTION

(71) Applicants: Vinith Beryl Canstance Robinson, Gig Harbor, WA (US); David Alexander Bishop, Gig Harbor, WA (US)

(72) Inventors: Vinith Beryl Canstance Robinson, Gig Harbor, WA (US); David Alexander Bishop, Gig Harbor, WA (US)

(21) Appl. No.: 18/498,904

(22) Filed: Oct. 31, 2023

(51) Int. Cl. A01K 11/00; A01K 29/00; G06F 3/14; G06F 3/16; G06V 40/10; G10L 17/26

(52) U.S. Cl. CPC A01K 11/006; A01K 29/005; G06F 3/14; G06F 3/16; G06V 40/10; G10L 17/26

(57) ABSTRACT

A system for animalia identification and species-specific interaction includes a presence detector configured to detect a presence of animalia, a biometric sensor configured to collect biometric data for identification of the animalia, an acoustic output device configured to emit an acoustic sound, and a processor communicatively coupled to the presence detector, the biometric sensor, and the acoustic output device. The processor is configured to activate the biometric sensor based on the detection of the presence of the animalia, receive the biometric data collected by the biometric sensor, analyze the biometric data to identify species of the animalia and instruct the acoustic output device to emit the acoustic sound, wherein the acoustic sound is selected from a set of acoustic sounds associated with the identified species of the animalia. A corresponding method is also disclosed.

### FIELD OF THE INVENTION

The present invention relates generally to a system and method for identifying animalia and interacting with the animalia. However, the present invention is not limited to this option, and it may further be adapted for different purposes.

### BACKGROUND OF THE INVENTION

The observation and identification of animalia in the field is a popular activity practiced by a wide range of people, including amateur animalia observers, as well as highly skilled vocational and professional animalia scientists. Typically, those personnel may use a magnifying scope or other optical devices to better view animalia specimens from a distance and allow closer visual examination of animalia specimens than what would be possible with the unaided eye. Also, electronic or computer systems and associated software have been developed which attempt to assist the observer in identifying observed animalia specimens.

However, several drawbacks are associated with the existing identification method. For example, identification by the observer is undesirably dependent on the skill and judgment of the observer, which may vary significantly from one observer to another. It also makes animalia identification by an unskilled or amateur observer particularly difficult. Moreover, the above identification methods are largely affected by weather conditions and cannot operate uninterruptedly for an extended period of time. In addition, those identification methods do not allow interaction with the animalia.

Therefore, it is an objective of the present invention to provide a means that overcomes the problems set forth above.

### SUMMARY OF THE INVENTION

In a first aspect of the present invention, a system for animalia identification and species-specific interaction is disclosed. The system includes a presence detector configured to detect a presence of animalia, a biometric sensor configured to collect biometric data for identification of the animalia, an acoustic output device configured to emit an acoustic sound, and a processor communicatively coupled to the presence detector, the biometric sensor, and the acoustic output device. The processor is configured to activate the biometric sensor based on the detection of the presence of the animalia, receive the biometric data collected by the biometric sensor, analyze the biometric data to identify species of the animalia and instruct the acoustic output device to emit the acoustic sound, wherein the acoustic sound is selected from a set of acoustic sounds associated with the identified species of the animalia.

In a second aspect of the present invention, a corresponding method for animalia identification and species-specific interaction is disclosed. The method comprises the steps of detecting a presence of an animalia, collecting biometric data for identification of the animalia based on the detection of the presence of the animalia, analyzing the biometric data to identify species of the animalia, and emitting an acoustic sound, wherein the acoustic sound is selected from a set of acoustic sounds associated with the identified species of the animalia.

### BRIEF DESCRIPTION OF THE DRAWINGS

The accompanying drawings, which are included to provide a further understanding of the invention, are incorporated in and constitute a part of this specification, illustrate an embodiment of the invention, and together with the description, serve to explain the principles of the invention. They are meant to be exemplary illustrations provided to enable persons skilled in the art to practice the disclosure and are not intended to limit the scope of the present invention. That is, the dimensions and relative placement of the components of the present invention, independently and in relation to each other can be different. It should be noted that the drawings are schematic and not necessarily drawn to scale. Some drawings are enlarged or reduced to improve drawing legibility.

FIG. 1 depicts a block diagram of the system of the present invention.

FIG. 2 depicts an exemplary networked operating environment for implementing an embodiment of the present invention.

FIG. 3 depicts a flowchart of an embodiment of the method of the present invention.

FIG. 4 depicts a flowchart of another embodiment of the method of the present invention.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of animalia identification and species-specific interaction, embodiments of the present disclosure are not limited to use only in this context.

The present invention discloses a system and method for animalia species identification and interaction. It is an aim of the present invention to provide a means for automatic identification of animalia in the field. It is another aim of the present invention to allow interaction with animalia when the species of the animalia is identified within a parameterized confidence level.

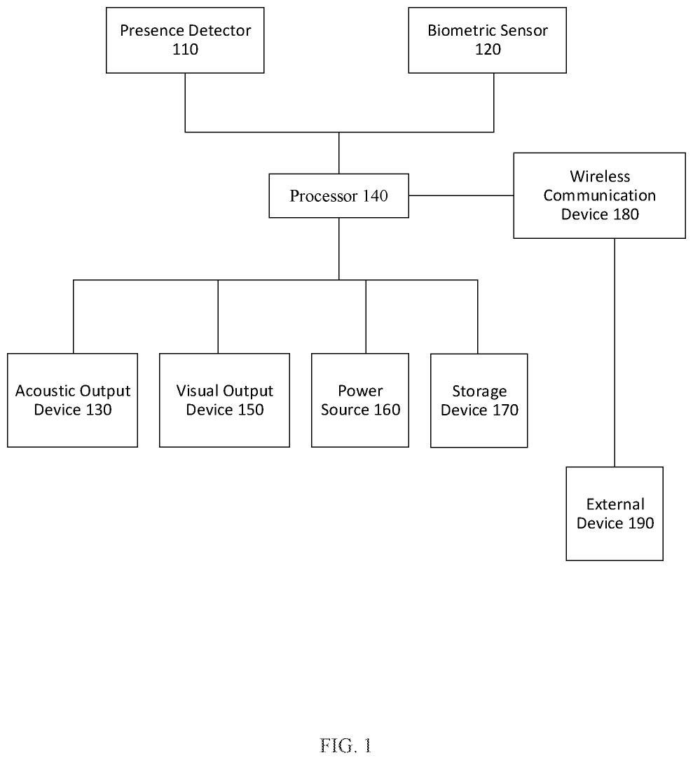

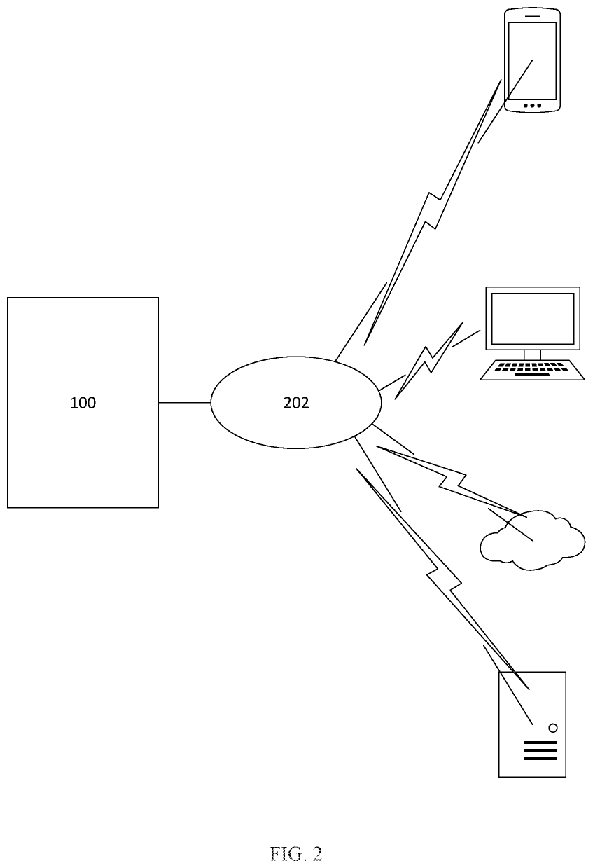

Referring now to the figures of the present disclosure. FIG. 1-2 depict the system 100 of the present invention. The system 100 for animalia identification and species-specific interaction comprises a presence detector 110, a biometric sensor 120, an acoustic output device 130, and a processor 140.

The presence detector 110 is configured to detect the presence of animalia. It should be noted that the presence detector 110 can be of any shape, size, material, features, type or kind, orientation, location, quantity, components, and arrangements of components that would allow the present invention to fulfill the objectives and intents of the present invention. In one embodiment, the presence detector 110 may be a motion sensor. Preferably, the motion sensor is a passive infrared (“PIR”) motion sensor that senses movements of animalia. The PIR motion sensor may generate an electric signal when detecting the movements of animalia and transmit the electric signal to the processor 140. In another embodiment, the presence detector 110 may be a camera. For example, the camera may continuously monitor the surrounding environment and send captured images or videos to the processor 140. The processor 140 may analyze the captured images or videos and determine if there is a moving animal or person. It should be noted that the motion sensor and the camera may be employed simultaneously for the purpose of improving the accuracy of presence detection. In other embodiments, the presence detector 110 may be any other suitable devices available currently or in the future.

The biometric sensor 120 is configured to collect biometric data for the identification of the animalia and communicate the biometric data to the processor 140. Upon receiving the electric signal sent by the presence detector 110, the processor 140 may activate the biometric sensor 120. It should be noted that the biometric sensor 120 can be of any shape, size, material, features, type or kind, orientation, location, quantity, components, and arrangements of components that would allow the present invention to fulfill the objectives and intents of the present invention. As used herein, the biometric data may include image data (e.g., that is representative of one or more images of the animalia), audio data (e.g., that is representative of a sound emitted by the animalia), etc.

In one embodiment, the biometric sensor 120 is a camera configured to capture an image or a video of the animalia and send the captured image or video to the processor 140. In another embodiment, the biometric sensor 120 is a bioacoustic sensor configured to record sounds of the animalia and send the sounds to the processor 140. It should be noted that the recorded sounds of the animalia may comprise infrasonic sounds, human audible sounds, or ultrasonic sounds. The audible range of human beings is around 20 Hz to 20000 Hz. Animals are able to emit a wide range of sound waves of multiple frequencies for communication. However, not all sound waves emitted by animals are audible to human beings. For example, rhinos, hippos, elephants, whales, octopuses, pigeons, squid, cuttlefish, cod, Guinea fowl, etc. communicate via infrasonic sounds (below 20 Hz), while bats, praying mantis, dolphins, dogs, frogs, toads, etc. can communicate via ultrasonic sounds (above 20000 Hz). Recording infrasonic sounds, human audible sounds, and ultrasonic sounds emitted by animalia would facilitate the identification of the species.

The acoustic output device 130 is configured to emit an acoustic sound. In one embodiment, the acoustic sound may be used to communicate with the animalia. In another embodiment, the acoustic sound may be used to influence the spatial behavior of the animalia, for example, to either allure it to enter a particular area or to deter it from entering a particular area. The acoustic sound emitted by the acoustic output device 130 may also comprise infrasonic sound, human audible sound, or ultrasonic sound. The acoustic output device 130 may be implemented with any suitable forms and may include one or more speakers.

The processor 140 is communicatively coupled to the presence detector 110, the biometric sensor 120, and the acoustic output device 130. The processor 140 is operable to execute software instructions to perform any method, method step, or sequence of method steps in any embodiment described in the application, in any order and with any degree of repetition. The processor 140 is implemented in hardware, firmware, and/or a combination of hardware and software. The processor 140 may take the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one embodiment, the processor 140 may be configured to activate the biometric sensor 120 based on the detection of the presence of the animalia. Once the presence detector 110 detects the presence of the animalia, the biometric sensor 120 can be activated by the processor 140 to collect biometric data of the animalia. The biometric data collected by the biometric sensor 120 is sent to and received by the processor 140. Upon receiving the biometric data, the processor 140 analyzes the biometric data to identify species of the animalia. Machine learning may be used to perform analysis on the biometric data in order to identify the species of the animalia. For example, a classification algorithm may be used to identify the species of the animalia.

The present invention establishes multiple sets of acoustic sounds, each set being associated with an animalia species. Once the species of the animalia is identified, the processor 140 instructs the acoustic output device 130 to emit the acoustic sound. The acoustic sound is selected from a set of acoustic sounds associated with the identified species of the animalia. If the species of the animalia cannot be identified, the processor 140 may be further configured to instruct the acoustic output device 150 to emit a preconfigured acoustic sound, for example, to influence the spatial movement of the species.

In a preferred embodiment, the biometric sensor 120 is further configured to record a reaction (images, videos, audio, etc.) of the animalia to the acoustic sound emitted by the acoustic output device 130. In an alternative embodiment, the present invention is provided with another separate biometric sensor to record the reaction (images, videos, audio, etc.) of the animalia to the acoustic sound. The processor 140 may be further configured to update the set of acoustic sounds associated with the identified species of the animalia. For example, a previously recorded animalia sound may be added to the set of acoustic sounds associated with the identified species of the animalia to test the reaction of the animalia to that sound. Moreover, one or more acoustic sounds may be removed from the set of acoustic sounds associated with the identified species of the animalia if the animalia does not respond to the acoustic sounds.

In one embodiment, the system of the present invention may further comprise a visual output device 150 coupled with the processor 140 and configured to generate a visual signal. The processor is further configured to instruct the visual output device to generate the visual signal, wherein the visual signal is selected from a set of visual signals associated with the identified species of the animalia. Similar to the acoustic sound sets, the present invention may comprise multiple sets of visual signals, each set being associated with an animalia species. The visual signals may be employed for either positive interactions with the species or to deter the species from entering an area. As an example, the visual output device 150 may be a light-emitting diode (“LED”) panel or a series of spatially distributed, physically discrete LED panels or other light-emitting devices. The visual output device may operate either within the human-visible light spectrum and/or in the human-invisible spectrum.

In a preferred embodiment, the system of the present invention may further comprise a wireless communication device 180 configured to communicate the biometric data to an external device 190 via a wireless network 202. Examples of the wireless network include Wi-Fi networks, Bluetooth networks, ZigBee networks, and the like. As shown in FIG. 2, the external device 190 may be a server, a cloud computing environment, a personal computing device, etc. In another embodiment, the external device 190 may be another instance of the system of the present invention.

In one embodiment, the system of the present invention may further comprise a power source 160 and a storage device 170. The power source 160 is used to supply power to other electric components of the present invention. The power source 160 may be any suitable power supply, such as a gas, chemical, or electrical power supply. For example, the power source 160 may be a solar panel power source. The storage device 170 stores information and/or software related to the operation and use of the system 100 of the present invention. For example, the storage device 170 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, memory card(s) and/or another type of non-transitory computer-readable medium currently available or made available in the future.

It should be noted that the components of the system of the present invention may be manufactured as a one-piece, integrally joined assembly. However, in other embodiments, the components may be separate from but nonetheless connected with each other physically or wirelessly.

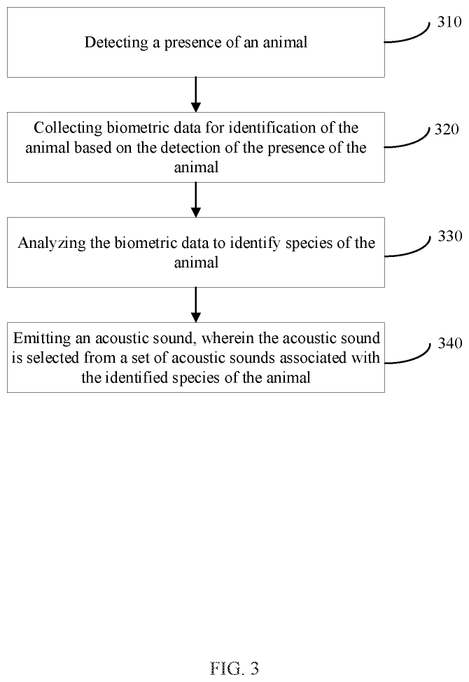

The present invention further discloses a corresponding method for animalia identification and species-specific interaction. As shown in FIG. 3, the method comprises a step of detecting a presence of an animalia at step 310. At step 320, biometric data is collected for identification of the animalia based on the detection of the presence of the animalia. The biometric data comprises an image, a video, or sounds of the animalia. The sounds of the animalia comprise infrasonic sounds, human audible sounds, or ultrasonic sounds. Then the biometric data is analyzed at step 330 to identify species of the animalia. Preferably, machine learning is employed to perform analysis on the biometric data in order to identify the species of the animalia. Once the species is identified, an acoustic sound is emitted at step 340, wherein the acoustic sound is selected from a set of acoustic sounds associated with the identified species of the animal. The acoustic sound comprises infrasonic sound, human audible sound, or ultrasonic sound.

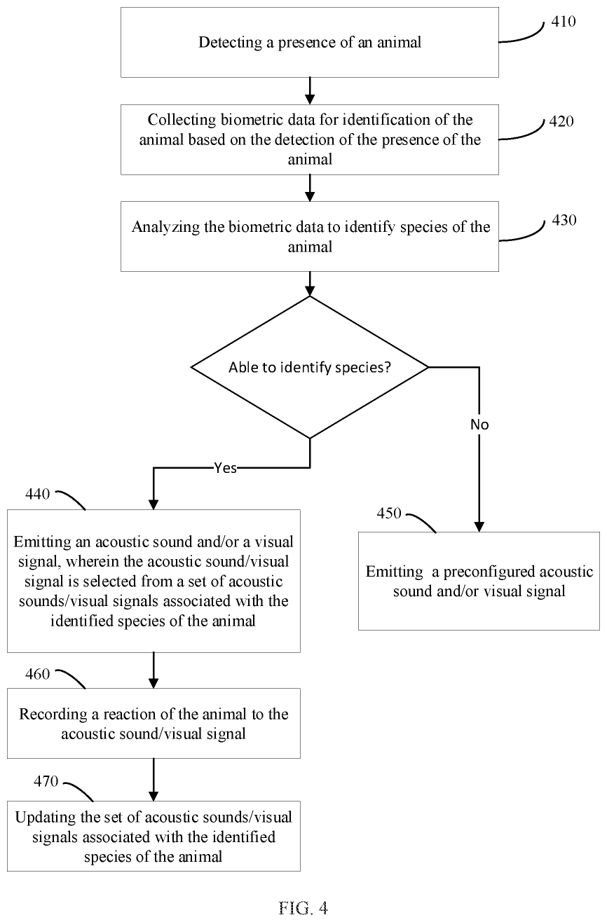

FIG. 4 illustrates another embodiment of the method of the present invention. Steps 410-440 are similar to steps 310-340 in FIG. 3. However, at step 440, as an alternative to or in addition to the acoustic sound, a visual signal may be generated. The visual signal is selected from a set of visual signals associated with the identified species of the animalia. Moreover, if the species of the animalia cannot be identified, a preconfigured acoustic sound and/or visual signal may be emitted at step 450. At step 460, a reaction of the animalia to the acoustic sound and/or visual signal may be recorded; and the set of acoustic sounds and/or visual signals associated with the identified species of the animalia may be updated at step 470.

Although the disclosure has been explained in relation to its preferred embodiment, it is to be understood that many other possible modifications and variations can be made without departing from the spirit and scope of the disclosure.

What is claimed is:

1. A system for animalia identification and species-specific interaction, comprising:
a presence detector configured to detect a presence of animalia;
a biometric sensor configured to collect biometric data for identification of the animalia;
an acoustic output device configured to emit an acoustic sound;
a processor communicatively coupled to the presence detector, the biometric sensor, and the acoustic output device;
wherein the biometric sensor is further configured communicate the biometric data to the processor;
wherein the processor is configured to:
activate the biometric sensor based on the detection of the presence of the animalia;
receive the biometric data collected by the biometric sensor;
analyze the biometric data to identify species of the animalia; and
instruct the acoustic output device to emit the acoustic sound, wherein the acoustic sound is selected from a set of acoustic sounds associated with the identified species of the animalia.

2. The system for animalia identification and species-specific interaction as claimed in claim 1, wherein the presence detector is a motion sensor, thermal detector, camera, or a combination thereof.

3. The system for animalia identification and species-specific interaction as claimed in claim 1, biometric sensor is a camera configured to capture an image or a video of the animalia.

4. The system for animalia identification and species-specific interaction as claimed in claim 1, wherein biometric sensor is a bioacoustic sensor configured to record sounds of the animalia.

5. The system for animalia identification and species-specific interaction as claimed in claim 4, wherein the sounds of the animalia comprise infrasonic sounds, human audible sounds, or ultrasonic sounds.

6. The system for animalia identification and species-specific interaction as claimed in claim 1, wherein the processor is configured to use machine learning to perform analysis on the biometric data in order to identify the species of the animalia.

7. The system for animalia identification and species-specific interaction as claimed in claim 1, wherein the acoustic sound emitted by the acoustic output device comprises infrasonic sound, human audible sound, or ultrasonic sound.

8. The system for animalia identification and species-specific interaction as claimed in claim 1, wherein the biometric sensor is further configured to record a reaction of the animalia to the acoustic sound.

9. The system for animalia identification and species-specific interaction as claimed in claim 8, wherein the processor is further configured to update the set of acoustic sounds associated with the identified species of the animalia.

10. The system for animalia identification and species-specific interaction as claimed in claim 1, further comprising a visual output device coupled with the processor and configured to generate a visual signal, wherein the processor is further configured to instruct the visual output device to generate the visual signal, and wherein the visual signal is selected from a set of visual signals associated with the identified species of animalia.

11. The system for animalia identification and species-specific interaction as claimed in claim 1, further comprising a wireless communication device configured to communicate the biometric data to an external device.

12. The system for animalia identification and species-specific interaction as claimed in claim 1, wherein the processor is further configured to instruct the acoustic output device to emit a preconfigured acoustic sound if the species of the animalia cannot be identified.

13. A method for animalia identification and species-specific interaction, comprising the steps of:
detecting a presence of an animalia;
collecting biometric data for identification of the animalia based on the detection of the presence of the animalia;
analyzing the biometric data to identify species of the animalia; and
emitting an acoustic sound, wherein the acoustic sound is selected from a set of acoustic sounds associated with the identified species of the animalia.

14. The method for animalia identification and species-specific interaction as claimed in claim 13, wherein the biometric data comprises an image, a video, or sounds of the animalia.

15. The method for animalia identification and species-specific interaction as claimed in claim 14, wherein the sounds of the animalia comprise infrasonic sounds, human audible sounds, or ultrasonic sounds.

16. The method for animalia identification and species-specific interaction as claimed in claim 13, wherein machine learning is employed to perform analysis on the biometric data in order to identify the species of the animalia.

17. The method for animalia identification and species-specific interaction as claimed in claim 13, wherein the acoustic sound emitted comprises infrasonic sound, human audible sound, or ultrasonic sound.

18. The method for animalia identification and species-specific interaction as claimed in claim 13, further comprising a step of recording a reaction of the animalia to the acoustic sound.

19. The method for animalia identification and species-specific interaction as claimed in claim 18, further comprising a step of updating the set of acoustic sounds associated with the identified species of the animalia.

20. The method for animalia identification and species-specific interaction as claimed in claim 13, further comprising a step of generating a visual signal, and wherein the visual signal is selected from a set of visual signals associated with the identified species of the animalia.
